(19) United States
(12) Patent Application Publication
(10) Pub. No.: US 2012/0205481 A1
(43) Pub. Date: Aug. 16, 2012

(54) FISHING LINE SPOOL DISPENSER

(75) Inventor: Mark E. Stout, Broken Arrow, OK (US)

(73) Assignee: EZ LINE SPOOL DISPENSER LLC, Broken Arrow, OK (US)

(21) Appl. No.: 13/025,433

(22) Filed: Feb. 11, 2011

(51) Int. Cl. A01K 97/00; B65H 59/04

(52) U.S. Cl. 242/423.1

(57) ABSTRACT

A fishing line spool dispenser comprising: a support rod; a spring stop in the support rod; a spring coiled around the support rod adjacent the spring stop; a first spindle adjacent the spring; a second spindle adjacent the first spindle; and a locking shaft collar adjacent the second spindle. A user may remove the locking shaft collar and the second spindle from the support rod; place a fishing line spool on the support rod; replace the second spindle and the locking shaft collar; slide all parts along the support rod to compress the spring against the spring stop; and temporarily secure the locking shaft collar to the support rod such that tension is maintained in the spring. The user may then load a reel with the even tensioned line dispensed from the fishing line spool. The support rod may be mounted to a base plate to which suction cups are secured. The user may attach the fishing line spool dispenser to a surface temporarily via the suction cups or may remove the suction cups and attach the base plate or the support rod itself to the surface for more permanent use.

### CROSS REFERENCE

Not Applicable.

### BACKGROUND OF THE INVENTION

1. Field of the Invention

This invention relates generally to a fishing line spool dispenser, and more particularly, but not by way of limitation, to a fishing line spool dispenser that provides adequate tension and may be temporarily or permanently mounted to a surface.

2. Description of the Related Art

Fishing line is typically sold on spools and must be wound onto a reel for use. Dispensing fishing line from a spool to a reel may be awkward, particularly for one person to accomplish alone. Often, two people are required, with one person holding the spool and the other winding the line onto the reel. Other times, a spool may be placed on a rod that allows the spool to rotate freely. With both of these methods, it is difficult to impossible to maintain consistent tension on the spool, and consequently on the line, resulting in snarls, tangles, and unevenly loaded reels.

Based on the foregoing, it is desirable a fishing line spool dispenser that maintains tension on the fishing line as the line is loaded onto the reel.

It is further desirable to provide such a fishing line spool dispenser that allows the user to adjust the amount of tension on the fishing line.

It is further desirable to provide such a fishing line spool dispenser that may be temporarily mounted to a variety of surfaces.

it is further desirable to provide such a fishing line spool dispenser that may alternately be mounted permanently to a surface.

### SUMMARY OF THE INVENTION

In general, in a first aspect, the invention relates to a fishing line spool dispenser comprising: a support rod; a spring stop in the support rod; a spring coiled around the support rod adjacent the spring stop; a first spindle adjacent the spring, where the support rod extends through the first spindle and the first spindle slides freely along the support rod and rotates freely about the support rod; a second spindle adjacent the first spindle, where the support rod extends through the second spindle and the second spindle slides freely along the support rod and rotates freely about the support rod; and a locking shaft collar adjacent the second spindle, where the support rod extending through the locking shaft collar and the locking shaft collar alternately may slide freely along the support rod or may be secured to the support rod temporarily to prevent movement of the locking shaft collar relative to the support rod. A user may remove the locking shaft collar and the second spindle from the support rod; place a fishing line spool on the support rod; replace the second spindle and the locking shaft collar on the support rod such that the second spindle is adjacent the fishing line spool and the locking shaft collar is adjacent the second spindle; slide the locking shaft collar, the second spindle, the fishing line spool, and the first spindle along the support rod to compress the spring against the spring stop; and temporarily secure the locking shaft collar to the support rod such that tension is maintained in the spring. The fishing line spool dispenser may further comprise a washer located between the spring stop and the spring, where the support rod extends through the washer; a washer located between the spring and the first spindle, where the support rod extends through the washer; a thumb screw, where the thumb screw temporarily secures the locking shaft collar to the support rod; and/or a pin extending through a hole in the support rod, comprising the spring stop.

The support rod may comprise: a horizontal upper portion with a first end and a second end, where the spring stop is located on the horizontal upper portion near the first end and the horizontal upper portion extends through the spring, first spindle, second spindle, and locking shaft collar with the spring located toward the second end from the spring stop, the first spindle located toward the second end from the spring, the second spindle located toward the second end from the first spindle, and the locking shaft collar located toward the second end from the second spindle; a vertical upper portion with an upper end and a lower end, where the upper end of the vertical upper portion is connected to and extends vertically downward from the first end of the horizontal upper portion; a horizontal lower portion with a first end and a second end, where the first end of the horizontal lower portion is connected to and extends horizontally from the lower end of the vertical upper portion such that the horizontal upper portion lies in a plane and the horizontal lower portion lies in the same plane as the horizontal upper portion, and the second end of the horizontal upper portion lies in a direction from the first end of the horizontal upper portion and the second end of the horizontal lower portion lies in the same direction from the first end of the horizontal lower portion as the horizontal upper portion; and a vertical lower portion with an upper end and a lower end, where the upper end of the vertical lower portion is connected to an extends vertically downward from the second end of the horizontal lower portion. The fishing line spool dispenser may have a center of gravity and the horizontal lower portion may be shorter than the horizontal upper portion, such that the vertical lower portion runs along the center of gravity of the fishing line spool dispenser. The horizontal upper portion, the vertical upper portion, the horizontal lower portion, and the vertical lower portion may be continuous, such that the support rod is a single rod that has been bent in three locations to form the horizontal upper portion, the vertical upper portion, the horizontal lower portion, and the vertical lower portion.

The lower end of the vertical lower portion may be threaded. The fishing line spool dispenser may further comprise a base plate with a threaded hole, where the threaded lower end of the vertical lower portion may be threaded into the threaded hole of the base plate. The hex nut may be threaded onto the threaded lower end of the vertical lower portion adjacent the base plate. The base plate may have four holes therethrough in addition to the threaded hole. The fishing line spool dispenser may further comprise four suction cups attached to the underside of the base plate. The four suction cups may be attached via four screws placed through the four holes in the base plate.

### BRIEF DESCRIPTION OF THE DRAWINGS

FIG. 1 is a front view of a fishing line spool dispenser, where the front and the back of the fishing line spool dispenser are identical; and

FIG. 2 is a top view of the base plate of the fishing line spool dispenser, where the top view and the bottom view of the base plate are identical.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

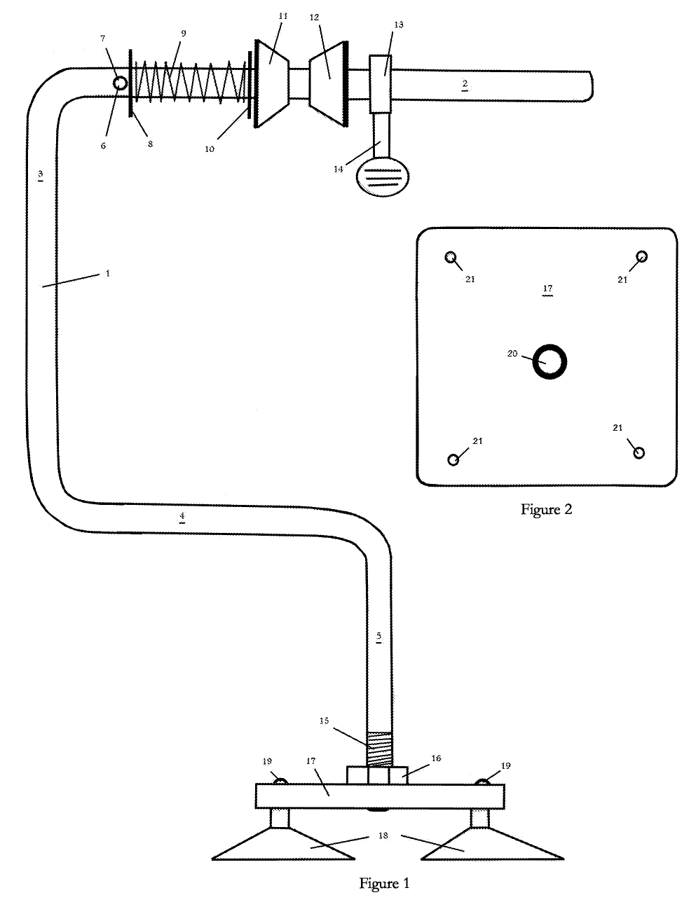

In general, in a first aspect, the invention relates to a fishing line spool dispenser as shown in FIG. 1. The fishing line spool dispenser has a support rod 1, which may have a horizontal upper portion 2; a vertical upper portion 3 extending downward from one end of the horizontal upper portion 2; a horizontal lower portion 4 extending horizontally from the lower end of the vertical upper portion 3 in the same direction as the horizontal upper portion 2 such that the horizontal upper portion 2, the vertical upper portion 3, and the horizontal lower portion 4 roughly form a C shape; and a vertical lower portion 5 extending downward from the end of the horizontal lower portion 4 opposite the end of the horizontal lower portion 4 attached to the vertical upper portion 3, such that the horizontal upper portion 2, the vertical upper portion 3, the horizontal lower portion 4, and the vertical lower portion 5 roughly form a question mark shape. The horizontal lower portion 4 may be shorter than the horizontal upper portion 2, such that the vertical lower portion 5 runs along the center of gravity of the fishing line spool dispenser. The horizontal upper portion 2, the vertical upper portion 3, the horizontal lower portion 4, and the vertical lower portion 5 may be formed of one continuous piece. For example, the entire support rod 1 may be a single rod that has been bent to the appropriate shape.

The horizontal upper portion 2 of the support rod 1 may have a spring stop 6 located near the end of the horizontal upper portion 2 that joins the vertical upper portion 3. The spring stop 6 may be a pin extending through a hole 7 in the support rod 1, or any other projection from the support rod 1 that is capable of stopping the movement of an item along the support rod 1. Moving along the horizontal upper portion 2 away from the vertical upper portion 3, a washer 8 may be adjacent the spring stop 6, with the support rod 1 extending through the washer 8. A spring 9 may be coiled around the support rod 1 adjacent the washer 8. A washer 10 may be adjacent the spring 9 opposite the washer 8, with the support rod 1 extending through the washer 10.

Still moving along the horizontal upper portion 2 away from the vertical upper portion 3, a first spindle 11 may be adjacent the washer 8 and a second spindle 12 may be adjacent the first spindle 11, with the support rod 1 extending through the first spindle 11 and the second spindle 12. The first spindle 11 and the second spindle 12 may rotate freely about the support rod 1. A locking shaft collar 13 may be adjacent the second spindle 12, with the support rod 1 extending through the locking shaft collar 13. The locking shaft collar 13, as well as the second spindle 12, the first spindle 11, the washer 10, the spring 9, and the washer 8, may slide freely along the support rod 1. However, the locking shaft collar 13 may be secured relative to the support rod 1 such that it cannot slide freely along the support rod 1 with a thumb screw 14.

In use, a user may loosen the thumb screw 14 and remove the locking shaft collar 13 and the second spindle 12 from the support rod 1. The user may then slide a fishing line spool onto the support rod 1 such that the fishing line spool is adjacent the first spindle 11. The user may then slide the second spindle 12 and the locking collar 13 back onto the support rod 1 such that the second spindle 12 is adjacent the fishing line spool and the locking collar 13 is adjacent the second spindle 12. The user may slide the washer 10, first spindle 11, fishing line spool, second spindle 12, and locking collar 13 toward the washer 8 and spring stop 6 such that the spring 9 is compressed, thus providing tension to the fishing line spool. When the user has achieved the desired tension, the user may tighten the thumb screw 14. The user may then pull the fishing line from the fishing line spool to load onto a reel. The fishing line spool rotates on the support rod 1, but the spring 9 imparts sufficient tension on the fishing line spool that the line is kept at a sufficient tension for consistent, tangle free loading of the reel.

The support rod 1 may terminate in a threaded end 15, where the threaded end is located on the end of the vertical lower portion 5 opposite the end of the vertical lower portion 5 that joins the horizontal upper portion 4. The threaded end 15 may thread into a threaded hole 20 in a base plate 17. A hex nut 16 may be first threaded onto the threaded end 15 adjacent the base plate 17. The base plate 21 may have four holes 21. Four suction cups 18 may be attached to the underside of the base plate 21 via screws 19 extending through the holes 21.

In use, a user may temporarily attach the fishing line spool dispenser to a surface by securing one or more of the suction cups 18 to the surface. The fishing line spool dispenser may be mounted to a vertical or horizontal surface, including upside down, or at any other angle depending on the angle of the surface. For a more permanent attachment, the user may remove the suction cups 18 from the base plate 17 and directly attach the base plate 17 to a surface with screws or other attachment devices placed through the holes 21. The user may also attach the fishing line spool dispenser to a smaller surface by removing the base plate 17 from the support rod 1 and directly placing the threaded end 15 of the support rod 1 into a threaded hole in the surface.

The fishing line spool dispenser may be partially or entirely aluminum or any other appropriate material or materials.

Whereas, the devices and methods have been described in relation to the drawings and claims, it should be understood that other and further modifications, apart from those shown or suggested herein, may be made within the spirit and scope of this invention.

What is claimed is:

1. A fishing line spool dispenser comprising:
a support rod;
a spring stop in the support rod;
a spring coiled around the support rod adjacent the spring stop;
a first spindle adjacent the spring, where the support rod extends through the first spindle and the first spindle slides freely along the support rod and rotates freely about the support rod;
a second spindle adjacent the first spindle, where the support rod extends through the second spindle and the second spindle slides freely along the support rod and rotates freely about the support rod; and
a locking shaft collar adjacent the second spindle, where the support rod extending through the locking shaft collar and the locking shaft collar alternately may slide freely along the support rod or may be secured to the support rod temporarily to prevent movement of the locking shaft collar relative to the support rod;
such that a user may remove the locking shaft collar and the second spindle from the support rod; place a fishing line spool on the support rod; replace the second spindle and the locking shaft collar on the support rod such that the second spindle is adjacent the fishing line spool and the locking shaft collar is adjacent the second spindle; slide the locking shaft collar, the second spindle, the fishing line spool, and the first spindle along the support rod to compress the spring against the spring stop; and temporarily secure the locking shaft collar to the support rod such that tension is maintained in the spring.

2. The fishing line spool dispenser of claim 1, further comprising a washer located between the spring stop and the spring, where the support rod extends through the washer.

3. The fishing line spool dispenser of claim 1, further comprising a washer located between the spring and the first spindle, where the support rod extends through the washer.

4. The fishing line spool dispenser of claim 1 further comprising a thumb screw, where the thumb screw temporarily secures the locking shaft collar to the support rod.

5. The fishing line spool dispenser of claim 1 where the spring stop comprises a pin extending through a hole in the support rod.

6. The fishing line spool dispenser of claim 1 where the support rod comprises:
a horizontal upper portion with a first end and a second end, where the spring stop is located on the horizontal upper portion near the first end and the horizontal upper portion extends through the spring, first spindle, second spindle, and locking shaft collar with the spring located toward the second end from the spring stop, the first spindle located toward the second end from the spring, the second spindle located toward the second end from the first spindle, and the locking shaft collar located toward the second end from the second spindle;
a vertical upper portion with an upper end and a lower end, where the upper end of the vertical upper portion is connected to and extends vertically downward from the first end of the horizontal upper portion;
a horizontal lower portion with a first end and a second end, where the first end of the horizontal lower portion is connected to and extends horizontally from the lower end of the vertical upper portion such that the horizontal upper portion lies in a plane and the horizontal lower portion lies in the same plane as the horizontal upper portion, and the second end of the horizontal upper portion lies in a direction from the first end of the horizontal upper portion and the second end of the horizontal lower portion lies in the same direction from the first end of the horizontal lower portion as the horizontal upper portion; and
a vertical lower portion with an upper end and a lower end, where the upper end of the vertical lower portion is connected to an extends vertically downward from the second end of the horizontal lower portion.

7. The fishing line spool dispenser of claim 6 where the fishing line spool dispenser has a center of gravity and where the horizontal lower portion is shorter than the horizontal upper portion, such that the vertical lower portion runs along the center of gravity of the fishing line spool dispenser.

8. The fishing line spool dispenser of claim 6 where the horizontal upper portion, the vertical upper portion, the horizontal lower portion, and the vertical lower portion are continuous, such that the support rod is a single rod that has been bent in three locations to form the horizontal upper portion, the vertical upper portion, the horizontal lower portion, and the vertical lower portion.

9. The fishing line spool dispenser of claim 6 where the lower end of the vertical lower portion is threaded.

10. The fishing line spool dispenser of claim 9 further comprising a base plate with a threaded hole, where the threaded lower end of the vertical lower portion may be threaded into the threaded hole of the base plate.

11. The fishing line spool dispenser of claim 10 further comprising a hex nut threaded onto the threaded lower end of the vertical lower portion adjacent the base plate.

12. The fishing line spool dispenser of claim 10 where the base plate has four holes therethrough in addition to the threaded hole.

13. The fishing line spool dispenser of claim 12 where the base plate has a top side and an under side, where the fishing line spool dispenser further comprises four suction cups attached to the underside of the base plate.

14. The fishing line spool dispenser of claim 13 where the four suction cups are attached to the underside of the base plate via four screws placed through the four holes in the base plate.
